(19) United States
(12) Patent Application Publication
(10) Pub. No.: US 2024/0278623 A1
(43) Pub. Date: Aug. 22, 2024

(54) MULTIMODAL COOLING SYSTEMS INCLUDING INTEGRATED COOLING DEVICES WITH REFRIGERANT-TO-COOLANT HEAT EXCHANGERS

(71) Applicant: GM Global Technology Operations LLC, Detroit, MI (US)

(72) Inventors: Karl Bo Albert MIKKELSEN, Peachland (CA); Rolf B. KARLSSON, Grand Blanc, MA (US); Michael Andrew SMITH, Clarkston, MI (US)

(21) Appl. No.: 18/110,944

(22) Filed: Feb. 17, 2023

(51) Int. Cl. B60H 1/32; B60H 1/00

(52) U.S. Cl. CPC B60H 1/323; B60H 1/00807; B60H 2001/00307; B60H 2001/00928

(57) ABSTRACT

A cooling system includes an integrated cooling device, a refrigerant circuit and a cooling circuit. The integrated cooling device is configured to draw thermal energy from a component of a vehicle. The integrated cooling device includes a body and a heat exchanger. The heat exchanger is embedded in the body. The heat exchanger includes an extended refrigerant channel and at least one of an extended coolant channel and a coolant reservoir. The extended refrigerant channel and the at least one of the extended coolant channel and the coolant reservoir drawing thermal energy from the body. The extended refrigerant channel draws thermal energy from the at least one of the extended coolant channel and the coolant reservoir. The refrigerant circuit is fluidically coupled to and circulates a refrigerant through the extended refrigerant channel. The coolant circuit is fluidically coupled to and circulates a coolant through the extended coolant channel.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to component cooling systems including both refrigerant and coolant loops.

A vehicle can include one or more coolant loops for cooling components, for example, under a hood of the vehicle, such as electrical components (e.g., one or more batteries, a controller, etc.). A vehicle can also include a heating, ventilation and air conditioning (HVAC) system, which can include a refrigerant loop including an evaporator, a condenser, a compressor, and an expansion valve. The HVAC system is used to adjust temperature within an interior cabin of the vehicle.

### SUMMARY

A cooling system is disclosed and includes an integrated cooling device, a refrigerant circuit and a cooling circuit. The integrated cooling device is configured to draw thermal energy from a component of a vehicle. The integrated cooling device includes a body and a heat exchanger. The heat exchanger is embedded in the body. The heat exchanger includes an extended refrigerant channel and at least one of an extended coolant channel and a coolant reservoir. The extended refrigerant channel and the at least one of the extended coolant channel and the coolant reservoir drawing thermal energy from the body. The extended refrigerant channel draws thermal energy from the at least one of the extended coolant channel and the coolant reservoir. The refrigerant circuit is fluidically coupled to and circulates a refrigerant through the extended refrigerant channel. The coolant circuit is fluidically coupled to and circulates a coolant through the extended coolant channel.

In other features, the body of the integrated cooling device is implemented as an integrated chiller and cold plate assembly including one or more cold plates. The extended refrigerant channel includes one or more refrigerant channels of the one or more cold plates. The extended coolant channel includes one or more coolant channels of the one or more cold plates.

In other features, the cold plate assembly includes cold plates.

In other features, refrigerant channels respectively of the cold plates are connected in series to provide the extended refrigerant channel. Coolant channels respectively of the cold plates are connected in series to provide the extended coolant channel.

In other features, each of the cold plates includes a refrigerant serpentine channel and a coolant serpentine channel extending parallel and adjacent to the refrigerant serpentine channel.

In other features, the heat exchanger includes the coolant reservoir.

In other features, the coolant reservoir is implemented as a surge tank.

In other features, the heat exchanger includes the extended coolant channel and the coolant reservoir.

In other features, the cooling system further includes: a refrigerant accumulator disposed in the body; and at least one expansion valve disposed in the body and fluidically coupled between the refrigerant accumulator and the extended refrigerant channel.

In other features, the cooling system further includes a phase change material layer attached to the body and contacting the component.

In other features, the cooling system further includes another heat exchanger embedded in the body. The another heat exchanger includes another refrigerant channel and another coolant channel.

In other features, the cooling system further includes one or more heat pipes drawing thermal energy from the body.

In other features, the refrigerant circuit includes a compressor, a condenser and at least one expansion valve. The coolant circuit includes at least one coolant pump and a tank.

In other features, a cooling system is provided and includes a reservoir, an integrated cooling device, a refrigerant circuit, and a coolant circuit. The reservoir is configured to hold coolant. The integrated cooling device is configured to draw thermal energy from a component of a vehicle. The integrated cooling device and the component are immersed in the coolant in the reservoir. The integrated cooling device including a refrigerant channel. The refrigerant channel drawing thermal energy from a body of the integrated cooling device. The refrigerant circuit is fluidically coupled to and circulating a refrigerant through the refrigerant channel. The coolant circuit is fluidically coupled to and circulating a coolant through the reservoir.

In other features, a method of operating a cooling system is provided. The method includes: determining a target amount of heat rejection to cool a component of a vehicle; estimating an amount of heat rejection provided by an integrated cooling device thermally coupled to the component; and based on the target amount of heat rejection and the estimated amount of heat rejection, selecting from a chiller mode, a coolant mode, and a maximum cooling mode, and operating in the selected one of the chiller mode, the coolant mode and the maximum cooling mode. The chiller mode includes cooling the component via a body of the integrated cooling device with a chiller circuit including a refrigerant channel embedded in the integrated cooling device. The coolant mode includes cooling the component with a coolant circuit including at least one of a coolant channel and a coolant reservoir embedded in the integrated cooling device. The maximum cooling mode includes running a compressor of the chiller circuit and coolant pumps of the coolant circuit.

In other features, the method further includes: operating in the chiller mode; while in the chiller mode, determining whether the estimated amount of heat rejection satisfies the target amount of heat rejection; and in response to the estimated amount of heat rejection not satisfying the target amount of heat rejection, operating in the chiller mode or the maximum cooling mode.

In other features, the method further includes: operating in the coolant mode; while in the coolant mode, determining whether the estimated amount of heat rejection satisfies the target amount of heat rejection; and in response to the estimated amount of heat rejection not satisfying the target amount of heat rejection, operating in the maximum cooling mode.

In other features, the chiller mode consumes less energy than the coolant mode and the maximum cooling mode. The coolant mode consumes more energy than the chiller mode and less energy than the maximum cooling mode.

In other features, operating in the chiller mode includes running the compressor to circulate refrigerant through the refrigerant channel.

In other features, operating in the coolant mode includes running at least one of the coolant pumps to circulate coolant through the at least one of the coolant channel and the coolant reservoir.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a functional block diagram of an example cooling system including an integrated chiller and cold plate assembly (ICCPA) in accordance with the present disclosure;

FIG. 2 is a functional block diagram of another example cooling system including an ICCPA and a second cold plate assembly in accordance with the present disclosure;

FIG. 3 is a functional block diagram of another example cooling system including an integrated cooling device with a reservoir in accordance with the present disclosure;

FIG. 4 is a functional block diagram of another example cooling system including an ICCPA with a liquid accumulator and valves in accordance with the present disclosure;

FIG. 5 is a functional block diagram of another example cooling system including an ICCPA and a phase change layer in accordance with the present disclosure;

FIG. 6 is a functional block diagram of another example cooling system including an integrated cooling device with dual chillers in accordance with the present disclosure;

FIG. 7 is a functional block diagram of another example cooling system including an integrated cooling device with a surge tank in accordance with the present disclosure;

FIG. 8 is a functional block diagram of another example cooling system including an ICCPA and a heat pipe thermally coupling the ICCPA to an external liquid tank in accordance with the present disclosure;

FIG. 9 is a functional block diagram of another example cooling system including an immersed cooling device and immersed cooled component in accordance with the present disclosure;

FIG. 10 is a perspective view of an example ICCPA in accordance with the present disclosure;

FIG. 11 is an exploded view of an example ICCPA including multiple dual plates sets connected in parallel for refrigerant and coolant flow paths in accordance with the present disclosure;

FIG. 12 is a top perspective view of a cold plate of an ICCPA in accordance with the present disclosure;

FIG. 13 is a side view of a portion of a ICCPA including a stack of cold plates configured similarly as the cold plate of FIG. 12;

FIG. 14 is a functional block diagram of a vehicle including a vehicle control system for controlling a cooling system in accordance with the present disclosure; and

FIGS. 15A-C illustrates a method of operating the vehicle control system of FIG. 14 in accordance with the present disclosure.

In the drawings, reference numbers may be reused to identify similar and/or identical elements.

### DETAILED DESCRIPTION

A cooling system to cool a safety critical component may include a cold plate and dual coolant loops. An example, of a safety critical component is a controller that controls operation of safety critical operations and components. For example, the controller may control autonomous vehicle operations, automotive safety restraint devices (e.g., air bags, seat belt tensioners, etc.), battery thermal management devices, etc. The cold plate draws thermal energy from the safety critical component to coolant in the dual coolant loops. The cold plate may include a first channel associated with the first coolant loop and a second channel associated with the second coolant loop. The first channel is disposed, for example, laterally separate and isolated from the second channel. Coolant in the first channel may be cooled by circulating the coolant through a radiator, which is external to the cold plate.

Coolant in the second channel may be cooled by circulating the coolant through a chiller. The chiller is separate from the cold plate and cools the coolant in the second channel via a refrigerant loop. The second coolant loop can serve as a backup to the first coolant loop and/or provide cooling in addition to the cooling provided by the first coolant loop. The chiller is part of a refrigerant loop, which may be part of a HVAC system. The refrigerant loop includes an evaporator, a condenser, a compressor, and an expansion valve. The HVAC system is used to adjust temperature within an interior cabin of the vehicle.

The stated cooling system includes many components, which have considerable mass and take up a considerable amount of space within a vehicle. The cooling system is complex and uses a considerable amount of energy.

The examples set forth herein include cooling systems with cold plate assemblies with integrated refrigerant and coolant heat exchangers and a corresponding thermal arbitration system for selecting operation in one of multiple different cooling modes. The cooling modes are selected to minimize the amount of electrical energy consumed while satisfying heat rejection targets and thus cooling requests. Each of the example implementations are configured to operate in a chiller mode, a coolant mode, and a dual (or maximum) cooling mode. The chiller mode refers to operating a refrigerant loop and not a coolant loop. The coolant mode refers to operating one or more coolant loops and not a chiller loop. The maximum cooling mode refers to operating a chiller loop and two coolant loops. Operation in the coolant mode may use more energy and provide more cooling than the chiller mode. Operation in the maximum cooling mode may use more energy and provide more cooling than the chiller mode and the coolant mode.

The multiple cooling modes provide redundancy and the ability to operate in one of the cooling modes if a cooling circuit associated with another one of the cooling modes is inoperable or is providing an abnormal amount of cooling. For example, one of the chiller mode and the coolant mode may be selected if the other one of the chiller mode and coolant mode is unable to be performed and/or is not providing an expected amount of cooling.

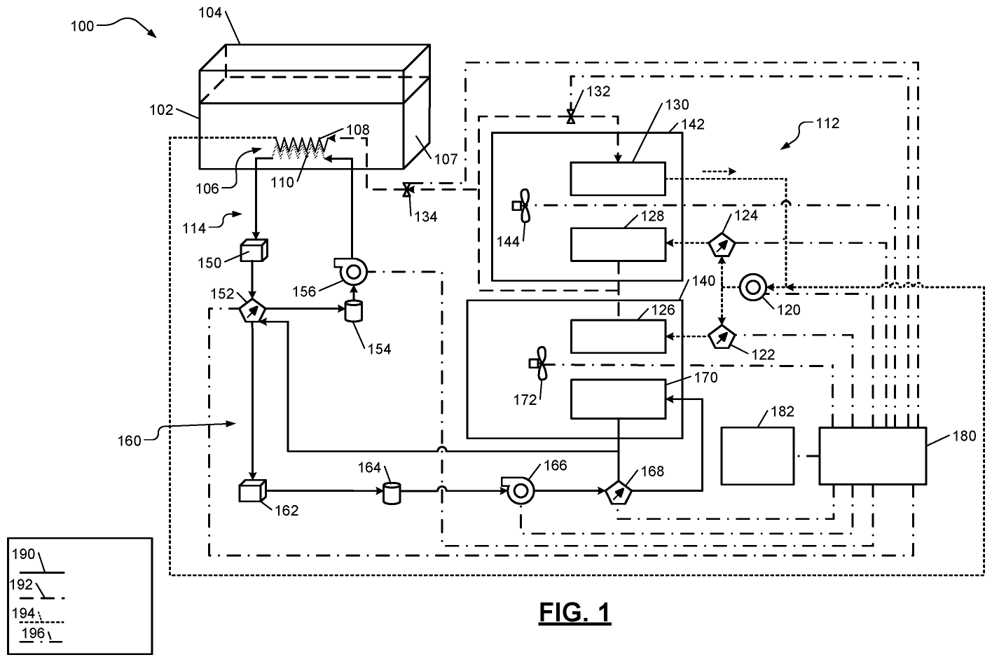

FIG. 1 shows a cooling system 100 that includes an ICCPA 102 for cooling a cooled component (or simply “the component”) 104. As an example, the ICCPA 102 may be replaced with and/or configured as any of the configurations shown in FIGS. 2-13. The component 104 may be, for example, a computer, a controller, a processor, one or more batteries, a battery pack, an inverter, etc. The component 104 may be a safety critical component that is used to perform safety critical operations, such as collision avoidance, object detection, occupant restraint system operations, battery overheat monitoring and temperature control operations, autonomous operations, braking and/or steering operations, etc. When a safety critical component overheats, the safety critical component may not operate appropriately. The cooling system 100 is configured to provide controlled and efficient cooling of the component 104 to prevent the component 104 from overheating. The cooling system 100 is a thermal management system that implements redundant thermal management modes for the component 104. The redundant thermal management modes including the chiller mode, the coolant mode and the maximum cooling mode.

The ICCPA 102 is an integrated cooling device that may include a body 107 having one or more cold plates and an integrated chiller 106. The chiller 106 performs as a heat exchanger between two channels 108, 110 (referred to as a refrigerant channel and a first coolant channel) of respectively a refrigerant loop 112 and a first coolant loop 114. The refrigerant channel 108 draws thermal energy from and thus cools the first coolant channel 110.

The refrigerant loop 112 may be referred to as a refrigerant circuit and includes the refrigerant channel 108, a compressor 120, control valves 122, 124, condensers 126, 128, evaporator 130, and expansion valves 132, 134. The condenser 126 is part of a condenser radiator fan module 140. The condenser 128 and evaporator 130 are part of a cabin HVAC module 142, which includes a first fan 144 that direct air across the condenser 128 for heating purposes and the evaporator 130 for cooling purposes.

The first coolant loop 114 may be referred to as a coolant circuit and includes the first coolant channel 110, one or more thermally managed devices (one thermally managed device 150 is shown), a control valve 152, a coolant surge tank 154, and a first coolant pump 156. The thermally managed devices may include other components and/or devices being cooled, such as batteries, charge ports, electronic components, etc. The first pump circulates a coolant through the first coolant loop 114. The control valve 152 directs coolant through the first coolant loop only or through the first coolant loop and a second coolant loop 160. The control valve 152 controls passage of coolant between the first and second coolant loops 114, 160. The second coolant loop 160 is fluidically coupled to the first coolant loop 114 depending on state of the control valve 152. The second coolant loop 160 can cool the coolant loop 114 or vice versa such that the coolant loop 114 cools the coolant loop 160. The coolant loops 114, 160 are also able to be fluidically and thermally separated from one another.

The second coolant loop 160 may be referred to as a coolant circuit and include the control valve 152, one or more thermally managed devices (one thermally managed device 162 is shown), a surge tank 164, a second coolant pump 166, another control valve 168, and a radiator 170. The radiator 170 is part of the condenser radiator and fan module 140. The thermally managed devices may include, for example, power electronics, such as a traction power inverter module, a drive motor, and an auxiliary power module. The condenser radiator and fan module 140 further includes a second fan 172 that directs air across the radiator and condenser for cooling purposes. The radiator cools the coolant in the second coolant loop 160. The second coolant pump 166 circulates the coolant through the second coolant loop 160.

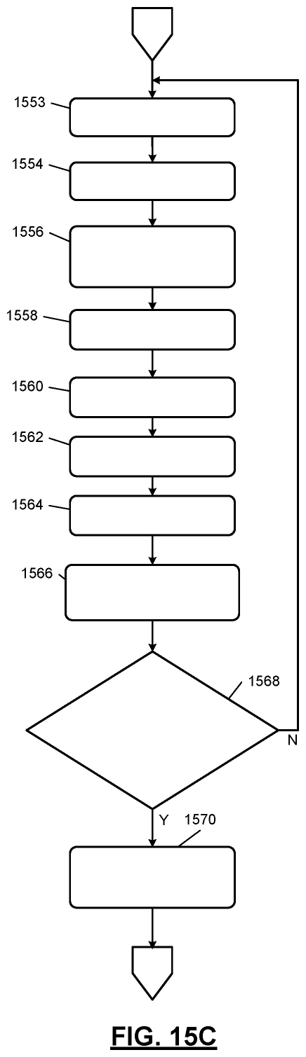

The cooling system 100 further includes a control module 180 and one or more aero shutters (one aero shutter 182 is shown). The control module 180 controls operation and states of the compressor 120, the valves 122, 124, 132, 134, 152, 168, the pumps 156, 166, and the fans 144, 172. This control is based on outputs from sensors, examples of which are shown in FIG. 14. In FIG. 1, coolant channels, which transfer coolant are designated by solid line 190, refrigerant channels which transfer liquid refrigerant are designated by dashed lines 192, and gas channels which transfer gas (or refrigerant in a gas state) are designated by dashed lines 194, and electrical lines are designated by dash-dot lines 196, as indicated by keys in FIGS. 1-9. The cooling system 100 may be controlled as described below with respect to the examples of FIGS. 14-15C. The cooling system 100 may be reconfigured to have any of the example configurations shown in FIGS. 2-9. The cooled components in FIGS. 2-9 may be the same or similar as the cooled component 104.

FIG. 2 shows a cooling system 200 that includes an ICCPA 202, a second cold plate assembly 204 and a cooled component 206. The ICCPA 202 and the second cold plate assembly 204 cool the cooled component 206, which is disposed between the ICCPA 202 and the second cold plate assembly 204. The ICCPA 202 and the second cold plate assembly may each include one or more cold plates. The ICCPA 202 is an integrated cooling device that includes a chiller 210 performs as a heat exchanger and includes a refrigerant channel 212 and a coolant channel 214. The refrigerant channel 212 is part of a refrigerant loop 216. The coolant channel 214 is part of a first coolant loop 218. The second cold plate assembly 204 includes a second coolant channel 217 of a second coolant loop 219.

The refrigerant loop 216 includes a compressor 220, a condenser 222, and an expansion valve 224. The first coolant loop 218 includes a first coolant pump 226 and a first surge tank 228. The second coolant loop 219 includes a second coolant pump 230 and a second surge tank 232.

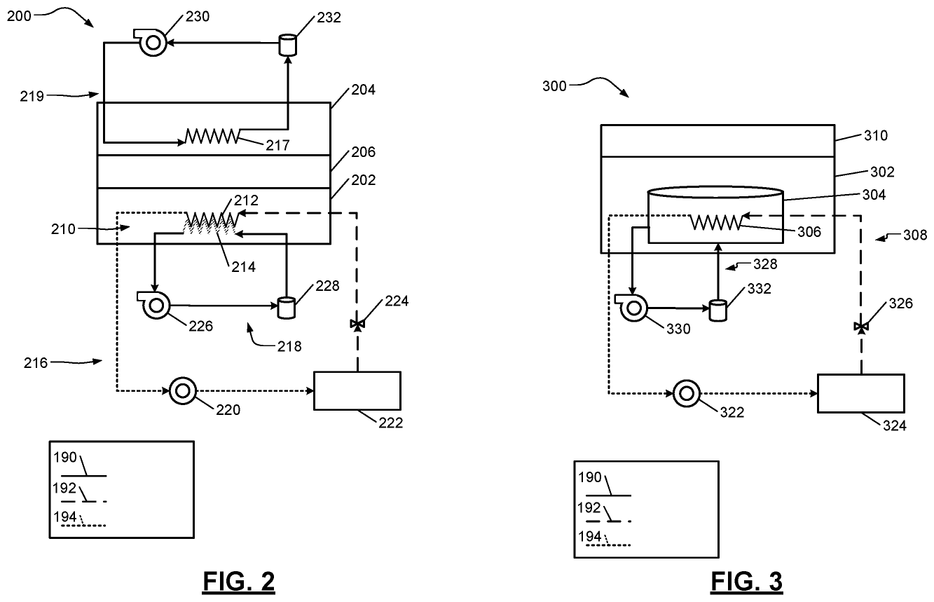

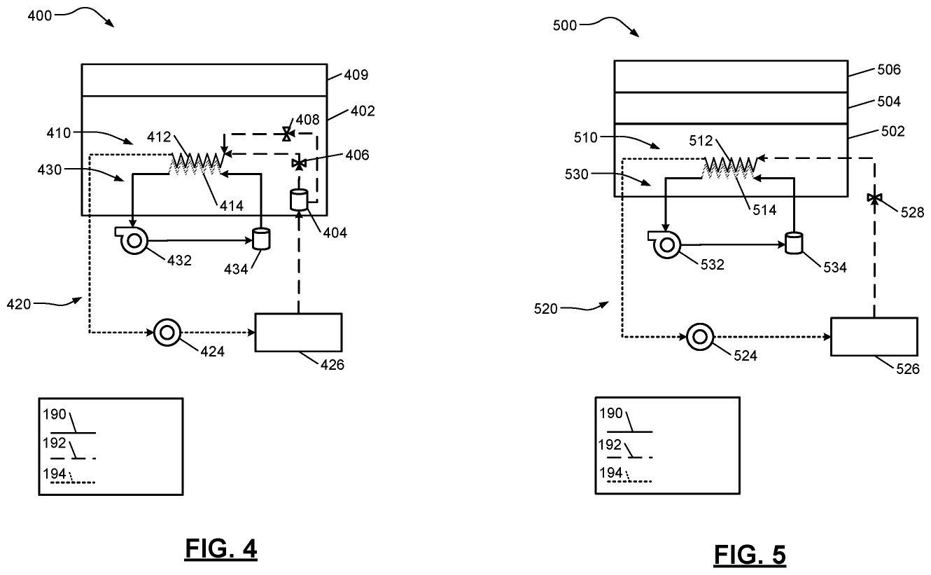

FIG. 3 shows a cooling system 300 that includes an integrated cooling device 302 with a reservoir 304. The integrated cooling device 302 includes a refrigerant channel 306 that is part of a refrigerant loop 308. The refrigerant channel 306 and the reservoir 304 perform as a heat exchanger. The integrated cooling device 302 cools a cooled component 310. The refrigerant channel 306 is disposed within the reservoir 304. The refrigerant channel 306 may be a serpentine shaped channel and be disposed in one or more plates, which may be connected in series and immersed in the coolant in the reservoir 304. The reservoir 304 provides a thermal buffer that resists temperature change due to the amount of coolant in the reservoir 304. The reservoir 304 is a cavity within the integrated cooling device 302. The cooling system 300 includes a refrigerant loop 308 including the refrigerant channel 306, a compressor 322, a condenser 324 and an expansion valve 326. The cooling system 300 includes a coolant loop 328 that includes a coolant pump 330 and a surge tank 332. Coolant is circulated from the reservoir 304 to the coolant pump 330, then to the surge tank 332 and then back to the reservoir 304.

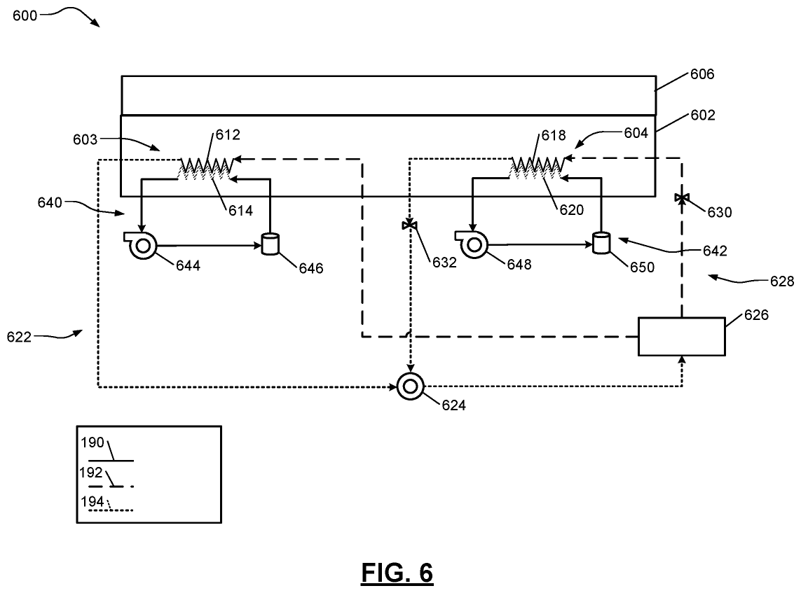

FIG. 4 shows a cooling system 400 that includes an ICCPA 402 with a liquid refrigerant accumulator 404 and relief (or expansion) valves 406, 408. The ICCPA 402 is an integrated cooling device that includes one or more cold plates and cools a cooled component 409. ICCPA 402 includes a chiller 410 that performs as a heat exchanger and includes a refrigerant channel 412 and a coolant channel 414. The cooling system 400 includes a refrigerant loop 420 that includes the refrigerant channel 412, compressor 424, condenser 426, the liquid refrigerant accumulator 404 and the relief valves 406, 408. The cooling system 400 further includes a coolant loop 430 that includes a coolant channel 414, a coolant pump 432, and a surge tank 434.

FIG. 5 shows a cooling system 500 that includes an ICCPA 502 and a phase change layer 504 disposed between the ICCPA 502 and a cooled component 506. The ICCPA 502 is an integrated cooling device that includes one or more cold plates and cools a cooled component 506. The ICCPA 502 includes a chiller 510 that performs as a heat exchanger and includes a refrigerant channel 512 and a coolant channel 514. The cooling system 500 includes a refrigerant loop 520 that includes the refrigerant channel 512, compressor 524, condenser 526, and an expansion valve 528. The cooling system 500 further includes a coolant loop 530 that includes a coolant channel 514, a coolant pump 532, and a surge tank 534. The phase change layer 504 includes phase change material, such as petroleum wax. The phase change layer 504 aids in transferring thermal energy between the ICCPA 502 and the cooled component 506.

FIG. 6 shows a cooling system 600 that includes an integrated cooling device (or cold plate assembly) 602 with dual chillers 603, 604. The ICCPA 602 is an integrated cooling device that includes one or more cold plates and cools a cooled component 606. The ICCPA 602 includes i) a first chiller 603 that performs as a heat exchanger and includes a refrigerant channel 612 and a coolant channel 614, and ii) the second chiller 604 that performs as a heat exchanger and includes a refrigerant channel 618 and a coolant channel 620.

The cooling system 600 includes a first refrigerant loop 622 that includes the refrigerant channel 612, a compressor 624, and a condenser 626. The compressor 624 and the condenser 626 are shared by the second refrigerant loop 628. The second refrigerant loop 628 further includes a first expansion valve 630 in series between the condenser 626 and the chiller 604. A second expansion valve 632 is in series between the chiller 604 and the compressor 624.

The cooling system 600 further includes a first coolant loop 640 and a second coolant loop 642. The first coolant loop 640 includes a first coolant pump 644 and a first surge tank 646. The second coolant loop 642 includes a second coolant pump 648 and a second surge tank 650.

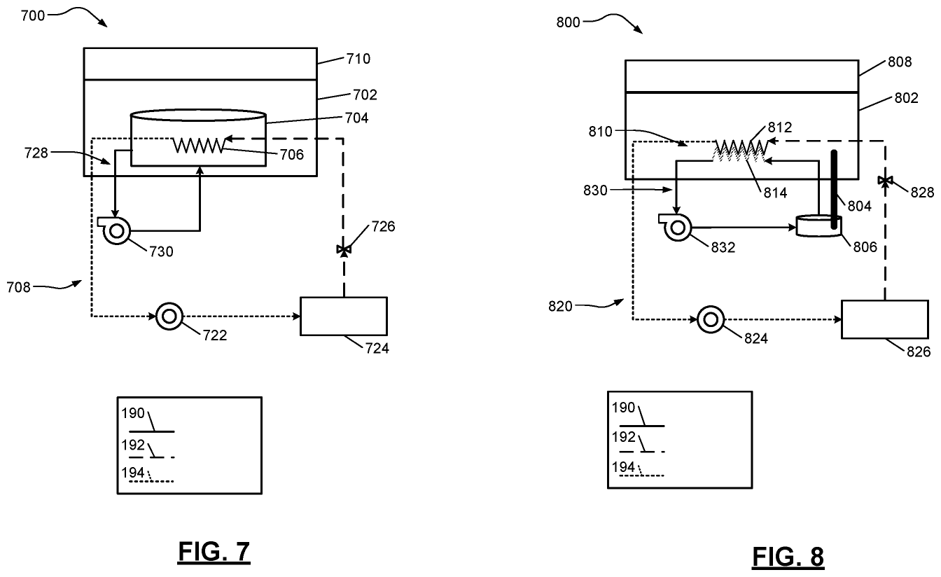

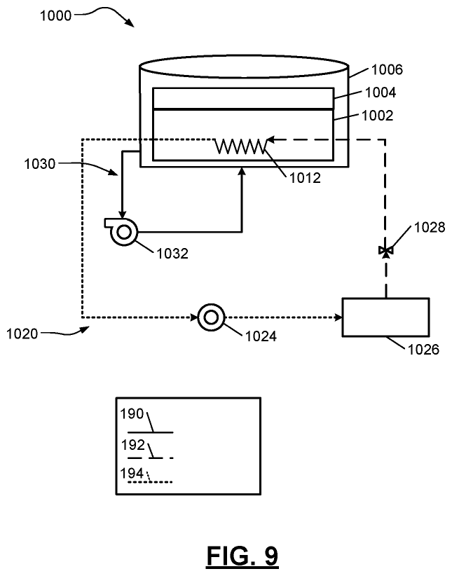

FIG. 7 shows a cooling system 700 that includes an integrated cooling device 702 with a surge tank 704. The integrated cooling device 702 includes a refrigerant channel 706 that is part of a refrigerant loop 708. The refrigerant channel 706 and the surge tank 704 perform as a heat exchanger. The integrated cooling device 702 cools a cooled component 710. The refrigerant channel 706 is disposed within the surge tank 704. The refrigerant channel 706 may be a serpentine shaped channel and be disposed in one or more plates, which may be connected in series and immersed in the coolant in the surge tank 704. The surge tank 704 provides a thermal buffer that resists temperature change due to the amount of coolant in the surge tank 704. The surge tank 704 is a cavity within the integrated cooling device 702. The cooling system 700 includes a refrigerant loop 708 including the refrigerant channel 706, a compressor 722, a condenser 724 and an expansion valve 726. The cooling system 700 includes a coolant loop 728 that includes a coolant pump 730. Coolant is circulated from the surge tank 704 to the coolant pump 730 and then back to the surge tank 704. The integrated cooling device 702 when implemented is packaged high relative to other components of the cooling system 700. The integrated cooling device 702 is also implemented for applications having available space to accommodate the size of the integrated cooling device 702 with the surge tank 704.

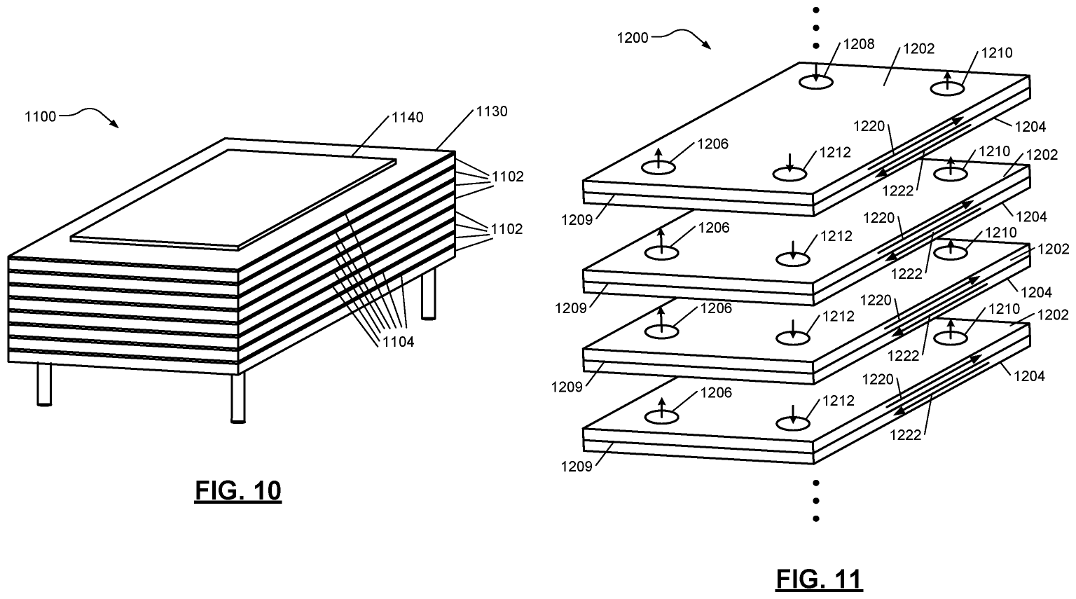

FIG. 8 shows a cooling system 800 that includes an ICCPA 802 and a heat pipe 804 thermally coupling the ICCPA 802 to an external liquid tank 806. The ICCPA 802 cools a cooled component 808. The ICCPA 802 is an integrated cooling device that may include one or more cold plates and a chiller 810 that performs as a heat exchanger. The ICCPA 802 includes a refrigerant channel 812 and a coolant channel 814. The cooling system 800 includes a refrigerant loop 820 that includes the refrigerant channel 812, compressor 824, condenser 826, and an expansion valve 828. The cooling system 800 further includes a coolant loop 830 that includes the coolant channel 814, a coolant pump 832, and the external liquid tank 806 coupled to the heat pipe 804. The heat pipe 804 draws thermal energy from the ICCPA 802 and transfers the thermal energy to the coolant in the external liquid tank 806. In an embodiment, the heat pipe 804 is partially embedded in the body of the ICCPA 802. In another embodiment, the heat pipe 804 is not embedded in the body of the ICCPA 802, but rather is connected to and draws thermal energy from the body. This arrangement may be utilized, for example, when the cooled component 808 and/or external liquid tank 806 cannot be packaged in the ICCPA 802. Although a single heat pipe is shown, more than one heat pipe may be included and drawing thermal energy from the body of the ICCPA 802.

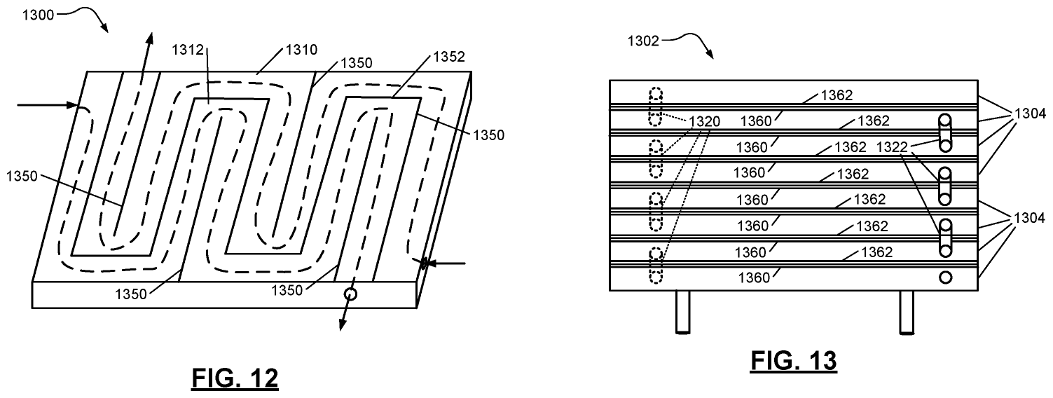

FIG. 9 shows a cooling system 1000 that includes a cooling device (or cold plate) 1002 and a cooled component 1004 that are immersed in a reservoir (or surge tank) 1006. The integrated cooling device 1002 cools the cooled component 1004. Coolant in the reservoir 1006 cools the cooled component 1004 and the integrated cooling device 1002. The integrated cooling device 1002 includes a refrigerant channel 1012. The refrigerant channel 1012 and the reservoir 1006 perform as a heat exchanger. The cooling system 1000 includes a refrigerant loop 1020 that includes the refrigerant channel 1012, compressor 1024, condenser 1026, and an expansion valve 1028. The cooling system 1000 further includes a coolant loop 1030 that includes the reservoir 1006 and a coolant pump 1032.

The above ICCPAs and integrated cooling devices of FIGS. 1-2, 4-6 and 8 that include one or more cold plates may be configured similarly as the ICCPAs of FIGS. 10-13. The integrated cooling devices of the embodiments of FIGS. 3 and 7 may include stacked cold plates, where each cold plate includes a single refrigerant channel. As an example, one or more of the cold plates of the ICCPAs of FIGS. 10-13 may include an inner cavity providing an internal reservoir or surge tank as shown in FIGS. 3-4 and 7. The inner cavity may be located in the center or at other locations within one or more stacked cold plates. In one embodiment, both a coolant channel (e.g., serpentine shaped coolant channel) and a reservoir or surge tank are included in a stack of cold plates and connected in series or in parallel.

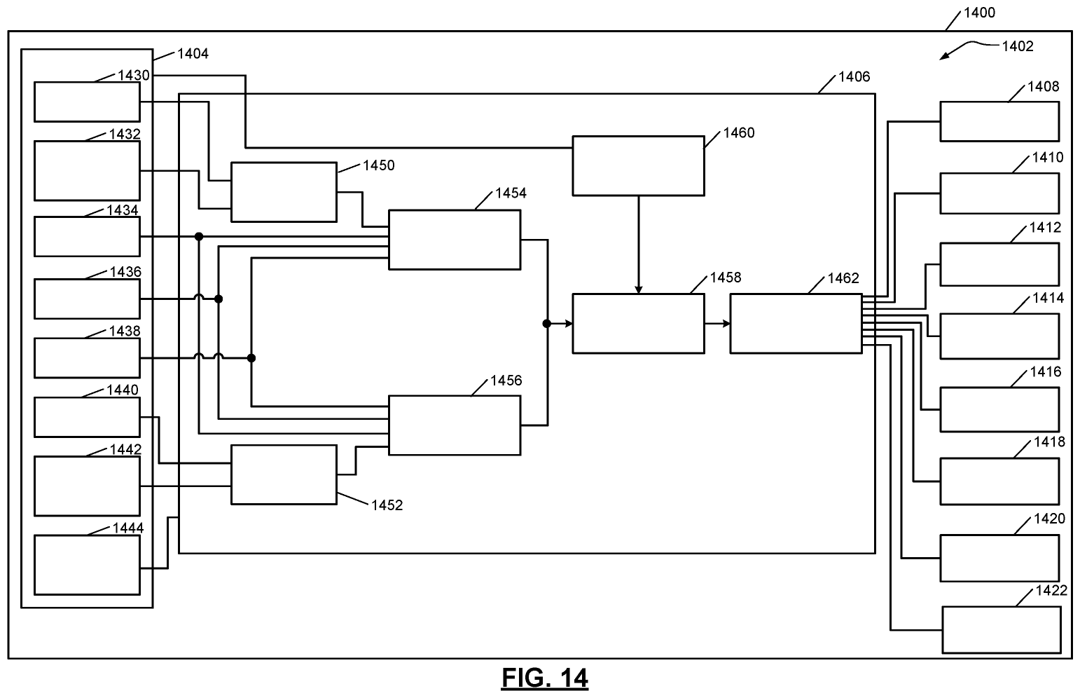

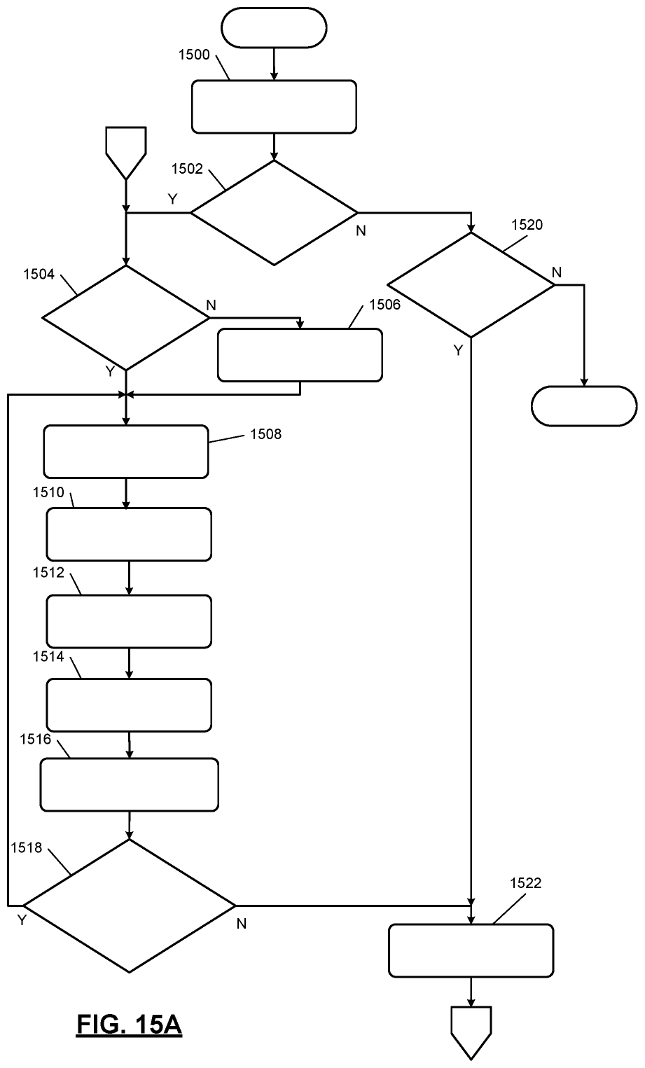

FIG. 10 shows an ICCPA 1100 that includes multiple stacked cold plates 1102. The ICCPA 1100 may replace any ICCPA referred to herein. The cold plates 1102 may each be a single cold plate similar to that shown in FIG. 12 or may each include a pair of plates similar to that shown in FIG. 11. The cold plates 1102 may be connected in series and/or in parallel depending on the arrangement of refrigerant and coolant channels. Each of the cold plates 1102 may have a cover plate 1104 including a layer of thermal interface material.

The ICCPA 1100 may include a top layer 1140 of phase change material, as described above, for connecting to a device or component being cooled. In addition, the aspect ratio (e.g., height vs width of a rectangular cross-section) of each of the channels of the cold plates 1102 may be adjusted to provide cold plate interfaces on, for example, upper or lower sides of the cold plates 1102. The aspect ratios may also be set for a particular application. As an example, the cold plates 1102 may be formed of aluminum, copper, and/or other suitable material.

FIG. 11 shows an ICCPA 1200 including multiple dual plate (or cavity) sets connected in parallel for refrigerant and coolant flow paths. The ICCPA 1200 may replace any of the ICCPAs referred to herein. Each dual plate set includes a refrigerant plate 1202 enclosing a refrigerant cavity having refrigerant and a coolant plate 1204 enclosing a coolant cavity having coolant. The refrigerant plate 1202 has input and output passages 1206, 1208. The coolant plate 1204 has input and output passages 1210, 1212. Each pair of plates has a metal layer (or plate) disposed between and in contact with the refrigerant of one side and the coolant on the opposite side. The metal layers are designated 1209. Refrigerant flows through the refrigerant plates 1202 in a first direction 1220. Coolant flows through the coolant plates 1204 in a second direction opposite the first direction as shown by arrows 1222. The plates 1202, 1204 of the ICCPA 1200 may be stamped plates that are brazed together. Each of the plates 1202, 1204 may have internal turbulators and/or fins to aid in thermal energy transfer.

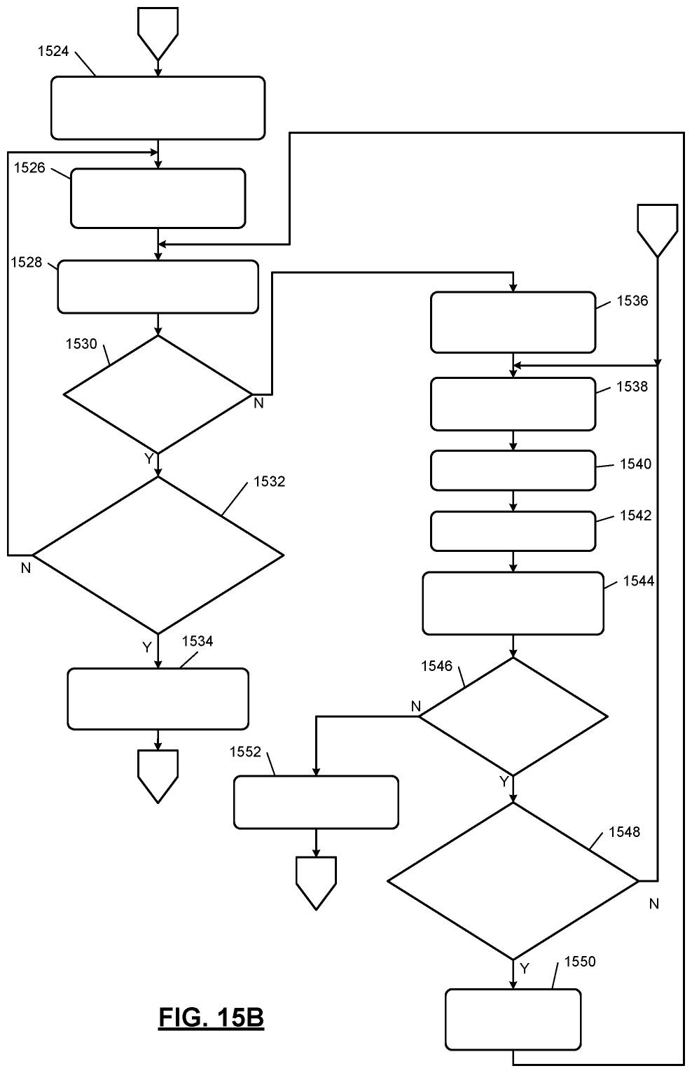

FIG. 12 shows a cold plate 1300 of an ICCPA such as any of the ICCPAs referred to herein. The cold plate 1300 may be implemented alone and/or in other arrangements such as in the examples of FIG. 10 or FIG. 13. The cold plate 1300 includes a refrigerant channel 1310 and a coolant channel 1312. Each of the channels 1310, 1312 has an input and an output on opposite ends of the corresponding channel and on opposite sides of the cold plate 1300. When multiple cold plates configured as the cold plate 1300 are stacked, the inputs and outputs of the cold plates may be coupled via couplers to connect the refrigerant channels in series or in parallel and to connect the coolant channels in series or in parallel. FIG. 12 shows some example couplers used for connecting inputs and outputs of refrigerant channels of multiple cold plates in series. Similar couplers may also be included for coolant channels of the cold plates.

The cold plate 1300 may include two serpentine passages (or channels) 1310, 1312. The serpentine passages of the cold plate 1300 may be connected to other serpentine passages of other cold plates to provide an extended refrigerant channel and an extended coolant channel. An extended channel may refer to a channel formed by serially connecting multiple channels respectively of multiple cold plates. The serpentine passages 1310, 1312 may be defined by peripheral sides of the cold plate 1300, turbulator and/or fin structures, and channel separators located within the cold plate 1300. The serpentine passage may have a wide aspect ratio. The example shown in FIG. 12 includes fins 1350, which cause the refrigerant and the coolant to make multiple turns, which causes turbulence and improves thermal energy transfer between the coolant in the coolant channel and the refrigerant in the refrigerant channel (i.e., improved heat transfer coefficient). A channel separator 1352 is shown. The cold plate 1300 may have a cover plate with a layer of thermal interface material. As an example, the cold plate 1300 may be cast and milled to provide the structure shown.

FIG. 13 is a side view of a portion of a ICCPA 1302 including a stack of cold plates, such as the cold plate 1300 of FIG. 12. The ICCPA 1302 includes cold plates 1304 that may be connected serially via, for example, channels or couplers 1320, 1322), which extend between the cold plates 1304. Four sets of couplers may be included, two sets per extended channel. Each set being on a side of the ICCPA 1302. Each of the cold plates 1304 has two channels, a refrigerant channel and a coolant channel. Two sets of couplers such as couplers 1320, 1322 may be included for each extended channel. The couplers 1320, 1322 are on two sides of the stack of the cold plates 1304. The couplers 1320, 1322 and the couplers for the other extended channel may be formed as part of the stack of cold plates 1304 or may be externally attached couplers. Although input and output ports of the channels of the cold plates 1304 are shown on certain sides and/or in certain locations, the input and output ports may be located elsewhere on the cold plates 1304. Each of the cold plates 1304 may have a cover plate with a layer of thermal interface material. This is shown by cover plates 1360 and thermal interface material layers 1362.

FIG. 14 shows a vehicle 1400 including a vehicle control system 1402 for controlling a cooling system, such as any cooling system disclosed herein. The vehicle 1400 includes sensors 1404, one or more control modules 1406 (e.g., a vehicle control module, a body control module, an engine control module, a transmission control module, etc.), and multiple cooling system devices. The cooling system devices may include a compressor 1408, one or more expansion valves 1410, a condenser radiator fan module (CRFM) 1412 (e.g., item 140 of FIG. 1), one or more coolant pumps 1414, a cabin HVAC module 1416 (e.g., cabin HVAC module 142 of FIG. 1), one or more rotary and/or control valves 1418, one or more aero shutters 1420, and/or other cooling system devices 1422.

The sensors 1404 may include a compressor speed sensor 1430, an expansion valve position sensors 1432, a vehicle speed sensor 1434, a CRFM fan speed sensor 1436, an ambient temperature sensor 1438, coolant pump speed sensors 1440, rotary valve position sensors 1442, and other sensors 1444, such as a cabin HVAC module fan speed sensor and control valve position sensors. The sensors 1430, 1432, 1434, 1436, 1438, 1440, 1442, 1444 may be used to monitor states of the devices 1408, 1410, 1412, 1414, 1416, 1418, 1420, 1422. The sensors 1404 may be used to detect and/or determine system inputs, such as heat flow from a cooled component (e.g., a safety critical component) Q_{SCC}, heat flow from components into a first coolant loop Q_{Cool1}, heat flow from components into a second coolant loop Q_{Cool2}, heat flow from the first coolant loop to the second coolant loop Q_{Cool2Cool}, heat flow from a cabin evaporator into a refrigerant loop Q_{Evap}, heat flow from a cabin condenser into an interior cabin Q_{CabCond}, heat flow from condenser into the environment Q_{cond}, heat flow from the radiator into the environment Q_{Rad}, cabin airflow requested, ambient temperature, vehicle speed, etc.

The one or more control modules 1406 may include a first heat rejection module 1450, a second heat rejection module 1452, a first estimated energy module 1454, a second estimated energy module 1456, an arbitration module 1458, a third heat rejection module 1460, and a heat rejection adjustment module 1462. In an embodiment, the modules 1450, 1452, 1454, 1456, 1458, 1460, 1462 include code executed by the one or more control modules 1406. The one or more control modules 1406, based on the outputs from the sensors 1404 and/or the above-stated system inputs, may determine, set, and/or adjust: speeds of coolant pumps 1414; coolant flow via rotary and control valves 1418 to different coolant loops and/or a radiator; refrigerant flow via rotary and control valves 1418 to condensers; compressor speed; positions of coolant expansion valves; CRFM fan speed; HVAC blower (or fan) speed; etc.

The first heat rejection module 1450 may estimate an amount of heat rejection of a refrigerant loop (also referred to as a chiller loop) based on compressor speed, positions of one or more expansion valves, vehicle speed, CRFM fan speed, and ambient conditions (e.g., ambient temperature). This may be compared to a requested (or target) amount of heat rejection for that refrigerant loop.

The second heat rejection module 1452 may estimate an amount of heat rejection of a one or more coolant loops based on speeds of one or more coolant pumps, positions of one or more rotary and/or control valves, vehicle speed, CRFM fan speed, and ambient conditions (e.g., ambient temperature). This may be compared to a requested (or target) amount of heat rejection for the coolant loop(s).

The first estimated energy module 1454 estimates an amount of heat capacity energy q_{chiller} of chiller per heat rejection period based on the estimated amount of heat rejection of a refrigerant loop, where q=mcΔT, where m is mass, c is specific heat and ΔT is change in temperature. The second estimated energy module 1456 estimates an amount of heat capacity energy q_{cool} of coolant loops per heat rejection period based on the estimated amount of heat rejection of the one or more coolant loop(s) (e.g., active coolant loop(s)).

The arbitration module 1458, based on the estimated amount of heat capacity energy q_{chiller} of the chiller, the estimated amount of heat capacity energy q_{cool} of coolant loops, and a requested amount of heat rejection Q_{req}, adjusts operation and/or states of cooling devices to minimize energy usage while satisfying a target cooling request. A requested amount of heat rejection Q_{req} is equal to or less than a sum of the estimated amount of chiller heat rejection Q_{chiller} and the estimated amount of coolant loop heat rejection Q_{coolant} when operating in the maximum cooling mode. In an embodiment, the chiller heat rejection Q_{chiller} and the coolant loop heat rejection Q_{coolant} are compared to a target amount of heat rejection and if either provides the target amount of heat rejection, the corresponding mode is selected. For example, if chiller heat rejection Q_{chiller} is greater than or equal to the target amount of heat rejection, then the chiller (or refrigerant) mode is selected. Similarly, if the coolant loop heat rejection Q_{coolant} is greater than or equal to the target amount of heat rejection, then the coolant mode is selected.

The arbitration module 1458 activates control states of cooling system devices of a refrigerant loop and one or more coolant loops to satisfy the target cooling request and/or target heat rejection while minimizing energy usage. This may include adjusting states of the cooling system devices to operate in the chiller (or refrigerant loop) mode, the coolant (or coolant loop) mode, or the maximum cooling (or refrigerant and coolant loop) mode. The maximum cooling mode using more energy than the chiller mode and the coolant mode. The adjustments may include adjustments to compressor speed, expansion valve positions, CFRM fan speed, coolant pump speeds, rotary and control valve positions, cabin HVAC blower (or fan) speeds, aero shutter positions, etc.

The third heat rejection module 1460 may determine the requested amount of heat rejection of, for example, an ICCPA based on the compressor speed, expansion valve positions, CFRM fan speed, coolant pump speeds, rotary and control valve positions, cabin HVAC blower (or fan) speeds, aero shutter positions.

The heat rejection adjustment module 1462 is configured to adjust the compressor speed, expansion valve positions, CFRM fan speed, coolant pump speeds, rotary and control valve positions, cabin HVAC blower (or fan) speeds, aero shutter positions based on a signal from the arbitration module 1458. In one embodiment, the arbitration module directly adjusts the compressor speed, expansion valve positions, CFRM fan speed, coolant pump speeds, rotary and control valve positions, cabin HVAC blower (or fan) speeds, aero shutter positions.

In one embodiment, a cooling mode is selected is based on operability of the chiller circuit and the coolant circuit. For example, if one of the chiller circuit and the coolant circuit is inoperable and/or is providing a reduced amount of cooling, the other one of the chiller circuit and the coolant circuit may be activated to satisfy a cooling request and/or to provide supplemental cooling.

In some embodiments, the chiller circuit and the coolant circuit provide two independent modes of cooling while enabling energy saving with independent operation of each circuit. This assures that the cooled component is able to be cooled when one of the circuits is inoperable or providing a below normal amount of cooling.

The one or more control modules 1406 may be implemented as a cooled component that is cooled using one of the example implementations of FIGS. 1-9.

FIGS. 15A-C shows a method of operating the vehicle control system 1402 of FIG. 14. The operations are applicable to the cooling systems of FIGS. 1-9. The operations of this method may be iteratively performed. These operations are provided as examples and may be performed in a different order and/or modified per the application, the heat rejection provided by different operating modes, and the energy usage in the different operating modes. The method may be performed by the one or more control modules 1406 (referred to below as the control module). Although the following operations are described including estimating amounts of heat rejection, determining target amounts of heat rejection, and performing operations based on these estimates and determinations, the operations may be energy based, where estimates of energy usage are determined and operations are performed based on which of multiple operating modes uses the least amount of energy while satisfying a cooling request. A cooling request may include a target amount of heat rejection, a target temperature for the component being cooled, and/or other cooling request.

Also, although the following operations include operating in a chiller mode and then if more heat rejection is warranted operating in a coolant mode, if the chiller mode provides more heat rejection and/or consumes more energy than the coolant mode, then the coolant mode may be implemented first followed by the chiller mode. In one embodiment, the cooling system operates in a single loop coolant mode (i.e., first coolant pump of first coolant loop is running and the first coolant loop is actively cooling the integrated cooling device and the second coolant pump of second coolant loop is OFF), followed by a chiller mode, followed by a dual loop coolant mode (i.e., both coolant pumps are running and actively cooling), followed by the maximum cooling mode, based on amounts of heat rejection and/or energy usage. The control module selects the operating mode that satisfies the target heat rejection and minimizes energy usage.

At 1500, the control module initiates cooling of a component (e.g., a safety critical component and/or other cooled component disclosed herein). This may be due to a cooling request having a target amount of cooling and/or heat rejection. This may include setting default states and/or looking up default states for cooling system devices, loading an algorithm to minimize energy usage and performing the above stated arbitration operations, and/or other initialization operations. Initialization may include determining an initial starting cooling mode, for example, starting in the chiller mode or the coolant mode based on the cooling request.

At 1502, the control module may determine whether to operate in the chiller mode and not the coolant mode and maximum cooling mode. If yes, operation 1504 may be performed to operate in the chiller mode, otherwise operation 1520 may be performed.

At 1504, the control module may determine whether a compressor is ON. If no, operation 1506 may be performed, otherwise operation 1508 may be performed.

At 1506, the control module starts the compressor. At 1508, the control module sets the compressor speed. This may be an initial default speed or based on a difference between an estimated amount of heat rejection and a target amount of heat rejection.

At 1510, the control module sets positions of one or more expansion valves. This may be initial default positions or based on the difference between the estimated amount of heat rejection and the target amount of heat rejection.

At 1512, the control module sets speed of fan (e.g., the fan 172 of FIG. 1). This may be an initial default speed or based on the difference between the estimated amount of heat rejection and the target amount of heat rejection.

At 1514, the control module sets positions of one or more aero shutters. This may be initial default positions or based on the difference between the estimated amount of heat rejection and the target amount of heat rejection.

At 1516, the control module estimates the amount of heat rejection for the chiller (or refrigerant) loop as described above and may also determine an updated target amount of heat rejection. The updated target amount of heat rejection may be based on an updated heat rejection request, which may be determined by the control module based on current conditions, for example, changes in ambient temperature, run time of the cooled component, etc.

At 1518, the control module determines whether the estimated amount of heat rejection satisfies the updated target amount of heat rejection. For example, the control module may determine whether the estimated amount of heat rejection provides greater than or equal to the target amount of heat rejection. If yes, operation 1508 may be performed, otherwise operation 1522 may be performed.

At 1520, the control module determines whether to operate in the coolant mode. If yes, operation 1522 is performed, otherwise the method may end. At 1522, the control module operates in the coolant mode and not the chiller mode and maximum coolant mode and proceeds to operation 1524.

At 1524, the control module selects and activates the first coolant loop, for example, the first coolant loop 114 of FIG. 1. This may include turning ON the first coolant pump, setting positions of one or more valves of the first coolant loop for circulation of coolant in the first coolant loop, and setting an initial speed of the first coolant pump. This may be based on the last target amount of heat rejection and/or a set initial default speed.

At 1526, the control module estimates amount of heat rejection of the first coolant loop and may determine an updated target amount of heat rejection. At 1528, the control module adjusts speed of the first coolant pump based on a difference in the estimated amount of heat rejection and the target amount of heat rejection. The controller may deactivate (i.e., shut OFF) the compressor if activated (i.e., ON). The control module may alternatively deactivate the compressor, for example, at operation 1522 or 1524.

At 1530, the control module may determine whether the estimated amount of heat rejection of the first coolant loop satisfies (i.e., is greater than or equal to) the target amount of heat rejection. If yes, operation 1532 may be performed, otherwise operation 1536 is performed.

At 1532, the control module may determine whether the estimated amount of heat rejection is greater than the updated target heat rejection by more than a predetermined amount (e.g., 10% more than target heat rejection). If yes, operation 1534 may be performed, otherwise operation 1526 may be performed. At 1534, the control module deactivates the first coolant pump and operates in the chiller mode and returns to operation 1504.

At 1536, the control module opens the rotary position valve for flow through the radiator. At 1538, the control module sets speed of the second coolant pump. This may be based on the difference between the last estimated amount of heat rejection and the target amount of heat rejection.

At 1540, the control module sets speed of fan (e.g., the fan 172 of FIG. 1). This may be based on the difference between the last estimated amount of heat rejection and the target amount of heat rejection.

At 1542, the control module sets positions of one or more aero shutters. This may be based on the difference between the last estimated amount of heat rejection and the target amount of heat rejection.

At 1544, the control module estimates a total amount of heat rejection of the first and second coolant loops and may determine an updated target amount of heat rejection. At 1546, the control module may determine whether the estimated amount of heat rejection of the first and second coolant loops satisfies the target amount of heat rejection. If yes, operation 1548 may be performed, otherwise operation 1552 is performed.

At 1548, the control module may determine whether the estimated amount of heat rejection is greater than the updated target heat rejection by more than a predetermined amount (e.g., 10% more than target heat rejection). If yes, operation 1550 may be performed, otherwise operation 1538 may be performed. At 1550, the control module may deactivate the second coolant pump.

At 1552, the control module operates in the maximum cooling mode and proceeds to operation 1553. At 1553, the control module sets speeds of fans (e.g., the fans 144, 172 of FIG. 1). This may be based on a difference between the last estimated amount of heat rejection and the target amount of heat rejection.

At 1554, the control module sets positions of one or more aero shutters. This may be based on a difference between the last estimated amount of heat rejection and the target amount of heat rejection.

At 1556, the control module sets position of rotary or control valve for coolant flow through radiator. This may be based on a difference between the last estimated amount of heat rejection and the target amount of heat rejection.

At 1558, the control module sets speed of first coolant pump. This may be based on a difference between the last estimated amount of heat rejection and the target amount of heat rejection.

At 1560, the control module sets speed of second coolant pump. This may be based on a difference between the last estimated amount of heat rejection and the target amount of heat rejection.

At 1562, the control module sets speed of compressor. This may be based on a difference between the last estimated amount of heat rejection and the target amount of heat rejection.

At 1564, the control module sets positions of one or more expansion valves. This may be based on a difference between the last estimated amount of heat rejection and the target amount of heat rejection.

At 1566, the control module estimates a total amount of heat rejection of the first and second coolant loops and chiller (or refrigerant) loop and may determine an updated target amount of heat rejection. At 1568, the control module may determine whether the estimated amount of heat rejection is greater than the updated target heat rejection by more than a predetermined amount (e.g., 10% more than target heat rejection). If yes, operation 1578 may be performed, otherwise operation 1553 may be performed. At 1570, the control module deactivates the compressor, operates in the coolant mode and returns to operation 1538.

The above-disclosed examples provide redundant cooling circuit and cooling modes to assure, for example, a safety critical component, is maintained at an appropriate temperature regardless of a fault and/or failure of one of the redundant cooling circuits. This is accomplished using two coolant loops and a single refrigerant loop. Additional loops are not needed. Effects of detected faults within any of the refrigerant and coolant loops are mitigated by the ability to operate one or the other refrigerant and coolant loops that are not experiencing a fault. The examples provide thermal management control with minimum energy usage by evaluating the net cooling load (or requested amount of cooling) for each component being cooled using a selected most energy efficient cooling mode to meet the net cooling load for current vehicle operating conditions. The examples reduce mass of cooling system components, costs of cooling system, energy usage, and cooling system complexity. The examples provide energy savings by allowing cooling loops to be turned OFF while continuing to provide cooling via one or more other cooling loops.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A cooling system comprising:
an integrated cooling device configured to draw thermal energy from a component of a vehicle, the integrated cooling device comprising
a body, and
a heat exchanger embedded in the body, the heat exchanger comprising an extended refrigerant channel and at least one of an extended coolant channel and a coolant reservoir, the extended refrigerant channel and the at least one of the extended coolant channel and the coolant reservoir drawing thermal energy from the body, and the extended refrigerant channel draws thermal energy from the at least one of the extended coolant channel and the coolant reservoir;
a refrigerant circuit fluidically coupled to and circulating a refrigerant through the extended refrigerant channel; and
a coolant circuit fluidically coupled to and circulating a coolant through the extended coolant channel.

2. The cooling system of claim 1, wherein the body of the integrated cooling device is implemented as an integrated chiller and cold plate assembly comprising one or more cold plates, wherein:
the extended refrigerant channel comprises one or more refrigerant channels of the one or more cold plates; and
the extended coolant channel comprises one or more coolant channels of the one or more cold plates.

3. The cooling system of claim 2, wherein the cold plate assembly comprises a plurality of cold plates.

4. The cooling system of claim 3, wherein:
a plurality of refrigerant channels respectively of the plurality of cold plates are connected in series to provide the extended refrigerant channel; and
a plurality of coolant channels respectively of the plurality of cold plates are connected in series to provide the extended coolant channel.

5. The cooling system of claim 3, wherein each of the plurality of cold plates comprises a refrigerant serpentine channel and a coolant serpentine channel extending parallel and adjacent to the refrigerant serpentine channel.

6. The cooling system of claim 1, wherein the heat exchanger comprises the coolant reservoir.

7. The cooling system of claim 1, wherein the coolant reservoir is implemented as a surge tank.

8. The cooling system of claim 1, wherein the heat exchanger comprises the extended coolant channel and the coolant reservoir.

9. The cooling system of claim 8, further comprising:
a refrigerant accumulator disposed in the body; and
at least one expansion valve disposed in the body and fluidically coupled between the refrigerant accumulator and the extended refrigerant channel.

10. The cooling system of claim 1, further comprising a phase change material layer attached to the body and contacting the component.

11. The cooling system of claim 1, further comprising another heat exchanger embedded in the body, the another heat exchanger comprising another refrigerant channel and another coolant channel.

12. The cooling system of claim 1, further comprising one or more heat pipes drawing thermal energy from the body.

13. The cooling system of claim 1, wherein:
the refrigerant circuit comprises a compressor, a condenser and at least one expansion valve; and
the coolant circuit comprises at least one coolant pump and a tank.

14. A cooling system comprising:
a reservoir configured to hold coolant;
an integrated cooling device configured to draw thermal energy from a component of a vehicle, the integrated cooling device and the component being immersed in the coolant in the reservoir, and the integrated cooling device comprising a refrigerant channel, the refrigerant channel drawing thermal energy from a body of the integrated cooling device;
a refrigerant circuit fluidically coupled to and circulating a refrigerant through the refrigerant channel; and
a coolant circuit fluidically coupled to and circulating a coolant through the reservoir.

15. A method of operating a cooling system, the method comprising:
determining a target amount of heat rejection to cool a component of a vehicle;
estimating an amount of heat rejection provided by an integrated cooling device thermally coupled to the component; and
based on the target amount of heat rejection and the estimated amount of heat rejection, selecting from a chiller mode, a coolant mode, and a maximum cooling mode, and operating in the selected one of the chiller mode, the coolant mode and the maximum cooling mode, the chiller mode comprising cooling the component via a body of the integrated cooling device with a chiller circuit comprising a refrigerant channel embedded in the integrated cooling device, the coolant mode comprising cooling the component with a coolant circuit comprising at least one of a coolant channel and a coolant reservoir embedded in the integrated cooling device, and the maximum cooling mode comprising running a compressor of the chiller circuit and coolant pumps of the coolant circuit.

16. The method of claim 15, further comprising:
operating in the chiller mode;
while in the chiller mode, determining whether the estimated amount of heat rejection satisfies the target amount of heat rejection; and
in response to the estimated amount of heat rejection not satisfying the target amount of heat rejection, operating in the chiller mode or the maximum cooling mode.

17. The method of claim 15, further comprising:
operating in the coolant mode;
while in the coolant mode, determining whether the estimated amount of heat rejection satisfies the target amount of heat rejection; and
in response to the estimated amount of heat rejection not satisfying the target amount of heat rejection, operating in the maximum cooling mode.

18. The method of claim 15, wherein:
the chiller mode consumes less energy than the coolant mode and the maximum cooling mode; and
the coolant mode consumes more energy than the chiller mode and less energy than the maximum cooling mode.

19. The method of claim 15, wherein operating in the chiller mode comprises running the compressor to circulate refrigerant through the refrigerant channel.

20. The method of claim 15, wherein operating in the coolant mode comprises running at least one of the coolant pumps to circulate coolant through the at least one of the coolant channel and the coolant reservoir.
